(19) United States
(12) Patent Application Publication
(10) Pub. No.: US 2023/0035533 A1
(43) Pub. Date: Feb. 2, 2023

(54) VEHICLE CONTROL SYSTEM AND METHOD

(71) Applicant: Transportation IP Holdings, LLC, Norwalk, CT (US)

(72) Inventors: Derek K. Woo, Melbourne, FL (US); Brian Lee Staton, Palm Bay, FL (US); Jason Ensign, West Melbourne, FL (US); Adam Franco, Melbourne, FL (US); Marshall Tetterton, West Melbourne, FL (US); Sanketh Bhat, Bengaluru (IN); Sahil Modi, Bengaluru (IN); Manthram Sivasubramaniam, Bengaluru (IN); Jayeshkumar Jayanarayan Barve, Bengaluru (IN)

(21) Appl. No.: 17/389,139

(22) Filed: Jul. 29, 2021

(51) Int. Cl. B60T 7/16; B61C 17/00; B61L 27/04; B61L 27/00; B60T 7/12

(52) U.S. Cl. CPC B60T 7/16; B61C 17/00; B61L 27/04; B61L 27/0005; B60T 7/128

(57) ABSTRACT

A method includes applying a brake system of a multi-vehicle system using an onboard controller device and receiving grade input at the onboard controller device from a remote controller device. The grade input indicates a grade of a surface on which the multi-vehicle system is disposed. The method further includes starting movement responsive to receiving a speed command signal at the onboard controller device from the remote controller device. The movement started by initiating release of the brake system and/or generating tractive effort from a propulsion system of the multi-vehicle system stretches the multi-vehicle system. The method further includes, responsive to the movement reaching a designated speed, switching to a closed loop control process of controlling the movement based on one or more of the speed command signal or a brake command signal received at the onboard controller device from the remote controller device.

### BACKGROUND

### Technical Field

The disclosed subject matter described herein relates to systems and methods for control of vehicle systems.

### Discussion of Art

Remote control technology is used to enable an operator to remotely control a vehicle system. For example, railway vehicles such as trains may be remotely controlled in a rail yard by a handheld operator control unit (OCU) for scenarios such as set outs, pick-ups, and locomotive movements in the yard. Remote control of rail vehicles in a rail yard can improve crew productivity, reduce car dwell time in the rail yard, reduce manpower for switching operations, and eliminate or reduce the need for a low-horse-power locomotive fleet.

Using remote control technology allows a single operator to conduct local pick-ups and drop-offs between origin and destination and set-out bad order cars. A single operator can bring stranded trains into congested rail yards if the road crews' time expires. Remote control technology also allows a yard-crew member to hostel mainline power around the yard, conduct switching operations, and build the train for departure. Mainline power can be used to build trains and conduct switching operations in the rail yard. Remote control technology can also be used in slow-speed loading and unloading operations, reducing the use of road crews and improving the efficiency of operations.

### BRIEF DESCRIPTION

In accordance with one embodiment, a method includes applying a brake system of a multi-vehicle system using an onboard controller device of the multi-vehicle system and receiving grade input at the onboard controller device from a remote controller device, the grade input indicating a grade of a surface on which the multi-vehicle system is disposed. The method further includes starting movement of the multi-vehicle system responsive to receiving a speed command signal at the onboard controller device from the remote controller device, the movement of the multi-vehicle system started by initiating release of the brake system and/or generating tractive effort from a propulsion system of the multi-vehicle system, wherein starting the movement of the multi-vehicle system stretches the multi-vehicle system. The method further includes responsive to the movement of the multi-vehicle system reaching a designated speed, switching to a closed loop control process of controlling the movement of the multi-vehicle system based on one or more of the speed command signal or a brake command signal received at the onboard controller device from the remote controller device.

### BRIEF DESCRIPTION OF THE DRAWINGS

The inventive subject matter may be understood from reading the following description of non-limiting embodiments, with reference to the attached drawings, wherein below:

FIG. 1 schematically depicts a system for remotely operating of a vehicle system according to one embodiment;

FIG. 2 schematically depicts a system for remotely operating a vehicle system according to one embodiment;

FIG. 3 schematically depicts a remote controller device according to one embodiment;

FIG. 4 schematically depicts a method according to one embodiment;

FIG. 5 schematically depicts a relationship between a gain of a closed loop control and a speed of the vehicle system;

FIG. 6 schematically depicts a method according to one embodiment;

FIG. 7 schematically depicts a method according to one embodiment; and

FIG. 8 schematically depicts a relationship between a current commanded speed of the vehicle system and a reference shaped speed.

### DETAILED DESCRIPTION

Embodiments of the subject matter described herein relate to systems and methods for remotely operating a vehicle system that includes a plurality of vehicles. The vehicle system may be operated remotely by an operator through a remote controller device. The vehicle system may be operated outside of a facility, such as a rail yard for example in the case of railway vehicles. The vehicle system may be operated at higher speeds and on mainline routes of the vehicle system for activities including setout, pick up, and/or repairs. The speed of the vehicle system may be regulated even if the composition of the vehicle system, the weight of the vehicle system, and/or the grade of the surface that the vehicle system is on are not known or incorrectly determined.

The speed of the vehicle system may be regulated during starting from zero speed. The speed may be regulated even if an operator enters incorrect or no information on the vehicle system weight, the vehicle system composition, or the initial grade. The speed of the vehicle system may be regulated from zero speed (i.e., from starting), during acceleration, and at different speeds, for example up to 40 mph. The speed of the vehicle system may also be regulated, by either accelerating or decelerating, from one target speed to another target speed. The speed of the vehicle system may also be regulated by decelerating to zero speed (i.e., stopping). The speed of the vehicle system may also be regulated to maintain coupler forces between the vehicles within limits.

An open loop control may be used for starting the vehicle system. Open loop control may also be used for regulating the speed of the vehicle system during stopping, for example during coast-to-idle or coast-to-brake modes of operation. Closed loop control may be used to regulate the speed of the vehicle system. The closed loop control may use Proportional-Integral-Derivative (PID) control.

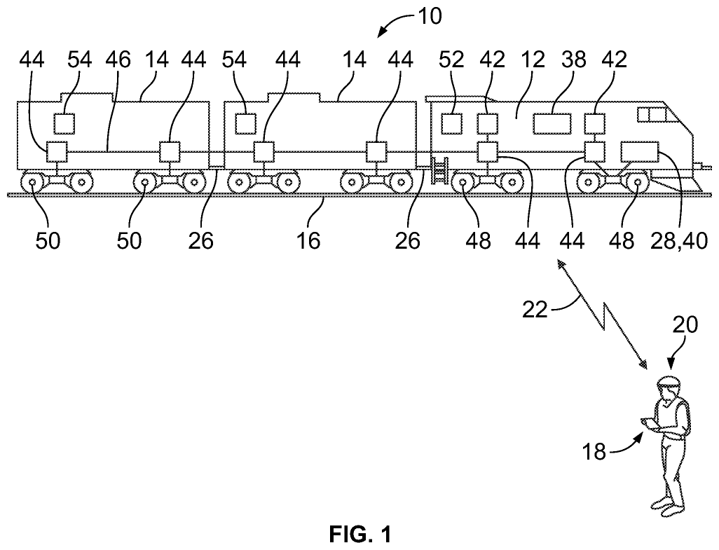

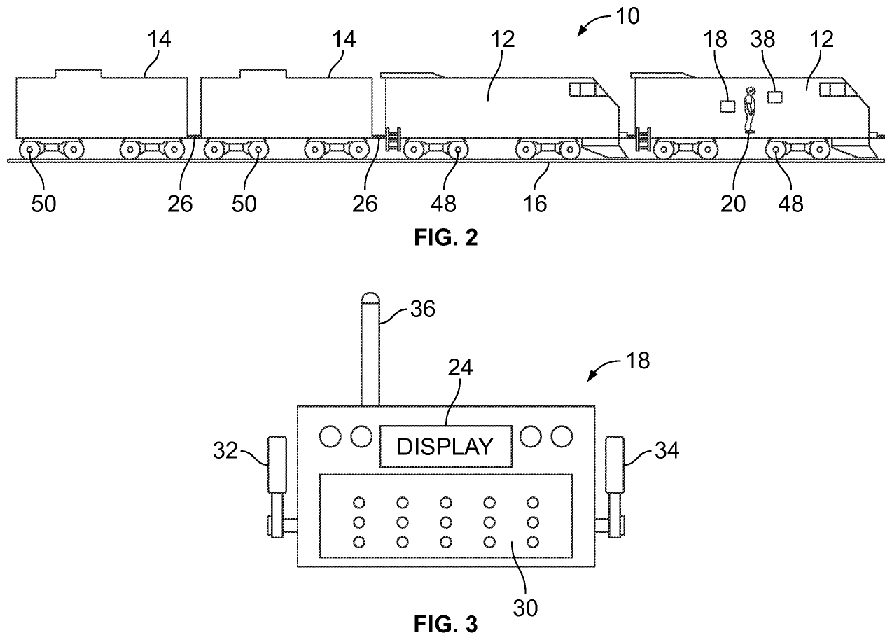

Referring to FIG. 1, a vehicle system 10 includes a propulsion-generating vehicle 12 and one or more non-propulsion generating vehicles 14 mechanically coupled together by couplers 26 while the vehicle system moves along a route 16. The non-propulsion-generating vehicles may be configured to carry one or more human passengers. According to one embodiment, the route may be in a facility, such as a railyard, or may be a main line route of a rail network for trains. The vehicle system represents a vehicle group. According to one embodiment, the vehicle group may include plural propulsion-generating vehicles (FIG. 2) and non-propulsion-generating vehicles. While the description herein describes a vehicle system being a rail vehicle group having locomotives as the powered vehicles and railcars as the non-powered vehicles (and the vehicle group is a train), alternatively, one or more embodiments described herein may be applied to other types of vehicle groups and/or vehicles. These other vehicle groups may include one or more off-highway vehicles (e.g., mining vehicles or other vehicles that may be not designed or legally permitted for travel on public roadways), marine vessels, automobiles, trucks, aircraft, or the like. Additionally, the vehicle system may be formed from a single vehicle instead of multiple vehicles. Optionally, in a vehicle system formed from several vehicles, the vehicles may be separate from each other but virtually or logically coupled with each other in that the vehicles communicate with each other to coordinate their movements with each other (so that the separate vehicles move together as a larger vehicle system, or convoy, along the routes).

Each propulsion-generating vehicle includes a propulsion system 28. The propulsion system may include on or more traction motors operably coupled with axles and/or wheels of the propulsion-generating vehicles. The traction motors may be connected with the axles and/or wheels via one or more gears, gear sets, or other mechanical devices to transform rotary motion generated by the traction motors into rotation of the axles and/or wheels to propel the vehicles and, consequently, the vehicle system. Different traction motors may be operably connected with different axles and/or wheels such that traction motors that may be deactivated (e.g., turned off) do not rotate corresponding axles and/or wheels while traction motors that remain activated (e.g., turned on) rotate corresponding axles and/or wheels.

The one or more propulsion generating vehicles include an onboard controller device 38. The onboard controller device may include a Proportional-Integral-Derivative (PID) controller. The onboard controller device may include a processor and a memory that stores instructions executable by the processor. The memory may also store data, including data received during operation of the vehicle system, for example while operated by remote control. The onboard controller device may also include a display to display information to an operator of the vehicle system and an input device, such as a touch screen or keyboard.

An operator 20 may remotely control operation of the vehicle system with a remote controller device, or operator control unit (OCU) 18. The remote controller device may send and receive signals 22 to and from one or more of the propulsion-generating vehicles. As shown in FIG. 1 the operator may be offboard the vehicle system while remotely controlling the vehicle system. As shown in FIG. 2, the operator may be onboard the vehicle system while remotely controlling the vehicle system. Referring to FIG. 3, the remote controller device includes a display 24 and an input interface 30 that allows the operator to input instructions to remotely control the one or more propulsion generating vehicles. The input interface may include switches or buttons or may be a keyboard or touch screen interface that accepts inputs from the operator. The remote controller device further includes a brake lever 32 and a throttle lever 34. The throttle lever may allow the operator to increase the speed of the vehicle system by adjusting the throttle lever from one discrete power setting, or notch, to another discrete power setting. The remote controller device includes an antenna 36 that sends the signals to the onboard controller device 38 onboard one or more of the propulsion-generating vehicles.

The propulsion-generating vehicle includes an independent braking system 42 that brakes wheels 48 of the propulsion-generating vehicle. The propulsion-generating vehicle also includes a dynamic braking system 40. The dynamic brake system can represent the traction motors operating in a regenerative braking mode in order to slow or stop movement of the vehicle. The vehicle system may further include an automatic braking system 44 for braking wheels 50 of the non-propulsion generating vehicles and the wheels of the propulsion-generating vehicle(s). The automatic braking system includes a brake pipe 46 that carries pressurized brake fluid (e.g., air) to activate the brakes for the wheels. The automatic brake system may be an Electronically Controlled Pneumatic (ECP) brake system that is controlled by the onboard controller device.

Sensors 52 may be provided on the one or more propulsion-generating vehicles and sensors 54 may be provided on the one or more non-propulsion-generating vehicles. The sensors may communicate by wire or wirelessly with the onboard controller device(s) of the one or more propulsion-generating vehicles. The sensors may provide visual data and sensor data. The sensors may include, but are not limited to, optical sensors such as digital video cameras, speed sensors, temperature sensors, oil pressure sensors, voltage sensors, current sensors, brake line pressure conveyed via end-of-train telemetry, operator input/output device status, and other locomotive sensors. Additional data that may be made available by sensors include, but not limited to, power notch setting, braking commands, and outputs of various engineer aids such as data produced by trip or rail network scheduling or optimizing systems. Other types of sensors that may provide data also include, but are not limited to, microphones, an accelerometer, digital thermometers, and location detection sensors, such as an onboard GPS system.

The remote controller device is configured to receive input from an operator, generate control signals based on the input, and to wirelessly communicate the control signals to the onboard controller device to control the movement of the vehicle system while the vehicle system moves along one or more routes, including one or more main line routes. As shown in FIG. 1, the remote controller device is configured to receive the input from the operator, generate the control signals, and wirelessly communicate the control signals while the remote controller device is offboard the vehicle system. As shown in FIG. 2, the remote controller device is configured to receive the input from the operator, generate the control signals, and wirelessly communicate the control signals while the remote controller device is onboard the vehicle system. The operator may be, or may not be, a certified or licensed locomotive operator.

The onboard controller device is configured to change a throttle setting of the propulsion system of the vehicle system to change the movement of the vehicle system based on the input that is received from the operator. The onboard controller device is configured to change a dynamic brake setting of the propulsion system of the vehicle system to change the movement of the vehicle system based on the input that is received from the operator. The onboard controller device is configured to change an independent brake setting of the brake system of the vehicle system to change the movement of the vehicle system based on the input that is received from the operator.

The remote controller device is configured to receive input from the operator of the remote controller device. According to one embodiment, one input may be a weight of the vehicle system and the remote controller device is configured to generate control signals based on the weight of the vehicle system. According to one embodiment, one input may be a grade on which the vehicle system is disposed and the remote controller device is configured to generate the control signals based on the grade.

According to one embodiment, the remote controller device is configured to receive one or more of a first number of propulsion-generating vehicles in the vehicle system or a second number of non-propulsion-generating vehicles in the vehicle system as the input from the operator and to generate the control signals based on the one or more of the first number or the second number. According to one embodiment, the vehicle system includes multiple propulsion-generating vehicles, and the onboard controller device is configured to synchronously control settings of one or more of the propulsion systems or the brake systems onboard the multiple propulsion-generating vehicles based on the control signals received from the remote controller device.

According to one embodiment, the remote controller device is configured to receive a speed set point as the input from the operator and to generate the control signals based on the speed set point.

According to one embodiment, the onboard controller device is configured to monitor inter-vehicle forces within the vehicle system, for example from sensors that determine forces on the couplers, and to control one or more of the propulsion system or the brake system based on the control signals received from the remote controller device to one or more of reduce the inter-vehicle forces or maintain the inter-vehicle forces within a designated range.

According to one embodiment, the onboard controller device is configured to restrict a frequency at which a throttle setting of the propulsion system is changed based on the control signals that are received from the remote controller device. According to one embodiment, the onboard controller device is configured to engage a dynamic brake of the brake system of the vehicle system responsive to the control signals received from the remote controller device directing the onboard controller device to stop the movement of the vehicle system.

The onboard controller device may include a proportional-integral-derivative (PID) controller and according to one embodiment the onboard controller device is configured to use a first set of control gains above a designated speed and a different, second set of control gains that change as a function of one or more operational parameters. The operational parameters include one or more of a weight of the vehicle system or a speed of the vehicle system.

According to one embodiment, the onboard controller device is configured to receive a current commanded speed that the vehicle system is to move. The onboard controller device is also configured to determine a current moving speed at which the vehicle system is moving and to calculate a reference shaped speed at which one or more of a propulsion system or a brake system of the vehicle system is directed to operate to cause the current moving speed of the vehicle system to approach the current commanded speed.

The reference speed determined by the onboard controller device is based on a reference shaping model that changes the reference speed based on relative values of the current commanded speed, a previous commanded speed that the vehicle system previously was commanded to move, the current moving speed of the vehicle system, and a previous reference shaped speed. The onboard controller device is configured to control the one or more of the propulsion system or the brake system to operate to cause the vehicle system to move at the reference shaped speed that is calculated.

According to one embodiment, the onboard controller device is configured to calculate the reference shaped speed by linearly increasing or linearly decreasing a previous value of the reference shaped speed.

According to one embodiment, the onboard controller device is configured to calculate the reference shaped speed by increasing or decreasing a previous value of the reference shaped speed at a rate that changes based on one or more of (a) a first difference between a current value of the reference shaped speed and the current commanded speed or (b) a second difference between the current moving speed of the vehicle system and one or more of the reference shaped speed or the current commanded speed. The onboard controller device is configured to calculate a faster value for the rate when the difference between the current value of the reference shaped speed and the current commanded speed is larger and a slower value when the difference between the current value of the reference shaped speed and the current commanded speed is smaller. The onboard controller device is configured to calculate a first designated value for the rate when the difference between the current value of the reference shaped speed and the current commanded speed is larger than a designated value and a second designated value for the rate that is slower than the first designated value when the difference between the current value of the reference shaped speed and the current commanded speed is no larger than the designated value.

According to one embodiment, the onboard controller device is configured to calculate the reference shaped speed by increasing or decreasing a previous value of the reference shaped speed at a first rate then a faster, second rate, followed by a slower, third rate.

According to one embodiment, the onboard controller device is configured to calculate the reference shaped speed by increasing or decreasing a previous value of the reference shaped speed according to a time invariant first order model.

According to one embodiment, the onboard controller device is configured to calculate the reference shaped speed by changing a previous value of the reference shaped speed according to a rate that is based on one or more of a weight of the vehicle system and the current moving speed.

According to one embodiment, the onboard controller device is configured to calculate a faster value for the rate when the difference between the current value of the reference shaped speed and the current commanded speed is larger and a slower value when the difference between the current value of the reference shaped speed and the current commanded speed is smaller.

According to one embodiment, the onboard controller device is configured to receive the current commanded speed from an operator input device, for example from the remote controller device.

According to one embodiment, the onboard controller device is configured to receive the current commanded speed from an automated control system.

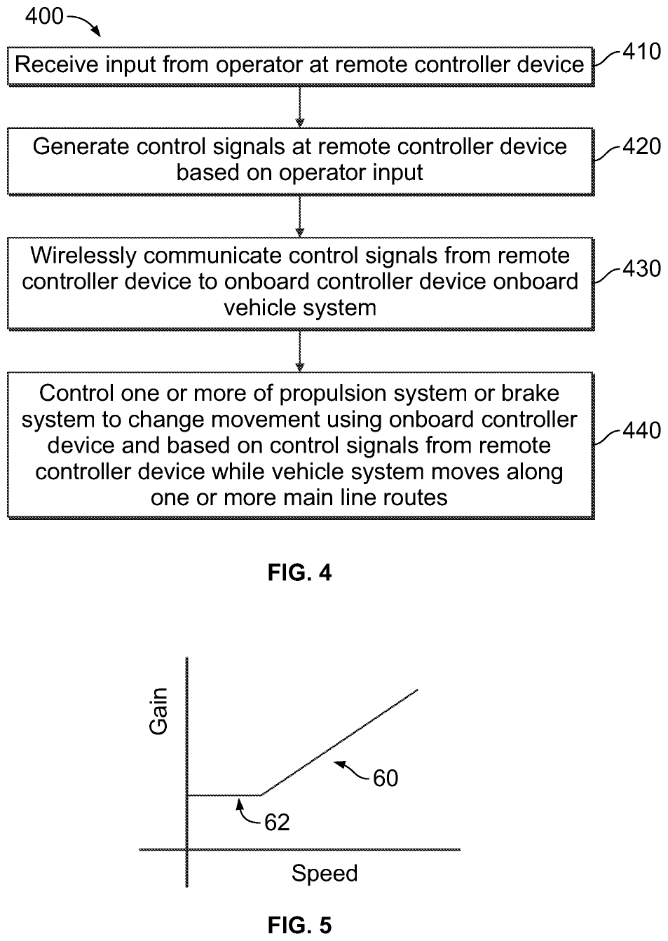

Referring to FIG. 4, a method 400 includes receiving input from an operator at a remote controller device of a vehicle control system 410 and generating control signals at the remote controller device based on the input from the operator 420. The method further includes wirelessly communicating the control signals from the remote controller device to an onboard controller device disposed onboard a vehicle system 430 and controlling one or more of a propulsion system or a brake system of the vehicle system to change movement of the vehicle system using the onboard controller device and based on the control signals that are received from the remote controller device while the vehicle system moves along one or more main line routes 440.

According to one embodiment, controlling the one or more of the propulsion system or the brake system includes changing a throttle setting of the propulsion system. Controlling the one or more of the propulsion system or the brake system may include changing a dynamic brake setting of the propulsion system. Controlling the one or more of the propulsion system or the brake system may include changing an independent brake setting of the brake system. Controlling the one or more of the propulsion system or the brake system may include controlling the movement of the vehicle system to move at speeds that exceed fifteen miles per hour.

According to one embodiment, receiving the input, generating the control signals, wirelessly communicating the control signals, and controlling the one or more of the propulsion system or the brake system occurs may occur while the remote controller device is offboard the vehicle system. According to one embodiment, receiving the input, generating the control signals, wirelessly communicating the control signals, and controlling the one or more of the propulsion system or the brake system occurs may occur while the remote controller device is onboard the vehicle system.

According to one embodiment, the vehicle system includes at least a first propulsion-generating vehicle that includes the propulsion system and a second non-propulsion-generating vehicle, and receiving the input, generating the control signals, wirelessly communicating the control signals, and controlling the one or more of the propulsion system or the brake system occurs while the remote controller device is onboard the non-propulsion-generating vehicle of the vehicle system.

According to one embodiment, the input that is received by the remote controller device includes one or more of a weight of the vehicle system, a grade on which the vehicle system is disposed, a first number of propulsion-generating vehicles in the vehicle system, a second number of non-propulsion-generating vehicles in the vehicle system, or a speed set point.

According to one embodiment, controlling the one or more of the propulsion system or the brake system includes adaptively limiting a frequency based on a controller mode at which a throttle setting of the propulsion system is changed based on the control signals that are received from the remote controller device.

According to one embodiment, the one or more of the propulsion system or the brake system includes engaging a dynamic brake of the brake system of the vehicle system responsive to the control signals received from the remote controller device directing the onboard controller device to stop the movement of the vehicle system.

According to one embodiment, controlling the one or more of the propulsion system or the brake system includes clamping a control gain that is output by a proportional-integral-derivative (PID) controller of the onboard controller device to the propulsion system of the vehicle system at speeds of the vehicle system that are slower than a designated speed limit. Referring to FIG. 5, the closed loop gain 60 is scheduled with respect to the mass of the vehicle system and the speed of the vehicle system. At low speeds, the gain value becomes too low. At low speeds the gain is kept at a threshold gain 62. By clamping the gain, undershoot and overshoot of the speed is reduced, on both ascending and descending grades.

Controlling the one or more of the propulsion system or the brake system may include transitioning from an open loop control mode to a closed loop control mode responsive to the vehicle system reaching the designated speed limit.

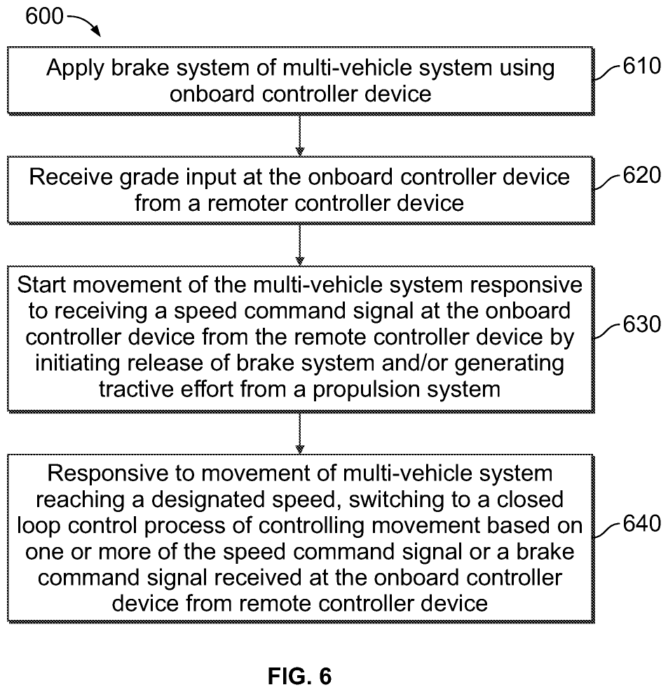

Referring to FIG. 6, a method 600 includes applying a brake system of a multi-vehicle system using an onboard controller device of the multi-vehicle system 610 and receiving grade input at the onboard controller device from a remote controller device 620. The grade input indicates a grade of a surface on which the multi-vehicle system is disposed. The method further includes starting movement of the multi-vehicle system responsive to receiving a speed command signal at the onboard controller device from the remote controller device 630. The movement of the multi-vehicle system is started by initiating release of the brake system and/or generating tractive effort from a propulsion system of the multi-vehicle system. Starting the movement of the multi-vehicle system stretches the multi-vehicle system. The method further includes, responsive to the movement of the multi-vehicle system reaching a designated speed, switching to a closed loop control process of controlling the movement of the multi-vehicle system based on one or more of the speed command signal or a brake command signal received at the onboard controller device from the remote controller device 640.

According to one embodiment, the grade input that is received at the onboard controller device indicates that the multi-vehicle system is on an ascending grade, and the method further includes maintaining application of the brake system while concurrently increasing the tractive effort that is generated by the propulsion system and determining whether the multi-vehicle system is rolling backward down the ascending grade. Responsive to determining that the multi-vehicle system is not rolling backward down the ascending grade, the method further includes releasing the brake system while continuing to generate the tractive effort at a first threshold level. Responsive to determining that the multi-vehicle system is rolling backward down the ascending grade, the method further includes maintaining application of the brake system while concurrently generating the tractive effort at a second threshold level that is greater than the first threshold level.

According to one embodiment, the grade input that is received at the onboard controller device indicates that the multi-vehicle system is on a flat grade, and the method further includes releasing the brake system at a configurable slew rate and concurrently generating the tractive effort with the propulsion system until the multi-vehicle system is stretched or the multi-vehicle system is moving forward.

According to one embodiment, the grade input that is received at the onboard controller device indicates that the multi-vehicle system is on a descending grade, and the method further includes verifying that one or more traction motors of the propulsion system are set up for dynamic braking, releasing the brake system at a configurable slew rate, and determining whether the multi-vehicle system is moving forward. Responsive to determining that the multi-vehicle system is moving forward, the method further includes engaging the one or more traction motors to dynamically brake to keep a moving speed of the multi-vehicle system to be no faster than the designated speed.

According to one embodiment, the method further includes determining that the multi-vehicle system is rolling backward in contradiction to the grade input that was received and engaging the brake system to stop the multi-vehicle system from rolling backward. The method further includes building up generation of the tractive effort provided by the propulsion system while concurrently engaging the brake system until the multi-vehicle system no longer rolls backward and releasing the brake system.

According to one embodiment, the closed loop control process of controlling the movement of the multi-vehicle system includes maintaining a speed of the multi-vehicle system at or within a threshold range of the speed command signal by alternating between (a) dynamically braking the multi-vehicle system using the propulsion system of the multi-vehicle system and (b) setting a throttle of the propulsion system to idle while the speed of the multi-vehicle system exceeds a designated stall speed of the multi-vehicle system to maintain the movement of the multi-vehicle. The method further includes applying the brake system of the multi-vehicle system responsive to (c) receiving an updated speed command signal at the onboard controller device from the remote controller device that reduces the speed of the multi-vehicle system and (d) the speed of the multi-vehicle system reaching the stall speed.

According to one embodiment, the brake system of the multi-vehicle system includes independent brakes, and the closed loop control process of controlling the movement of the multi-vehicle system includes maintaining a speed of the multi-vehicle system at or within a threshold range of the speed command signal by alternating between (a) applying the independent brakes of the multi-vehicle system and (b) setting a throttle of the propulsion system to idle while the speed of the multi-vehicle system exceeds a designated stall speed of the multi-vehicle system to maintain the movement of the multi-vehicle. The method further includes applying the independent brakes of the multi-vehicle system responsive to (c) receiving an updated speed command signal at the onboard controller device from the remote controller device that reduces the speed of the multi-vehicle system and (d) the speed of the multi-vehicle system reaching the stall speed.

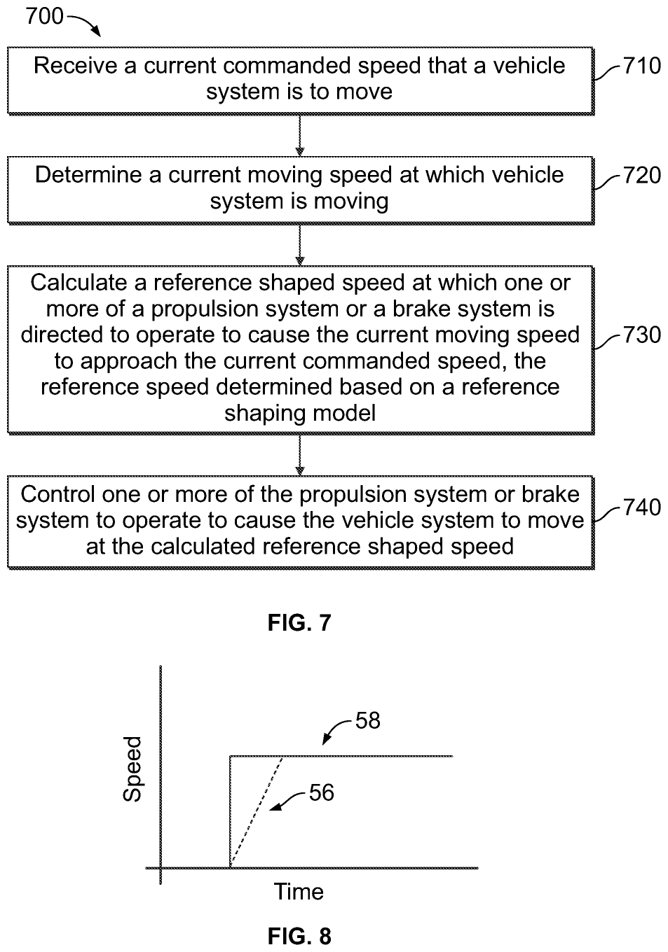

Referring to FIG. 7, a method 700 includes receiving a current commanded speed that a vehicle system is to move 710 and determining a current moving speed at which the vehicle system is moving 720. To reduce undershoot and overshoot, the current commanded speed may be increased and decreased gradually at a configurable slew rate of the onboard controller device. The method further includes calculating a reference shaped speed at which one or more of a propulsion system or a brake system of the vehicle system is directed to operate to cause the current moving speed of the vehicle system to approach the current commanded speed 730. Referring to FIG. 8, the reference shaped speed 56 is calculated to approach the current commanded speed 58. The reference speed is determined based on a reference shaping model that changes the reference speed based on relative values of the current commanded speed, a previous commanded speed that the vehicle system previously was commanded to move, and the current moving speed of the vehicle system. Referring again to FIG. 7, the method further includes controlling the one or more of the propulsion system or the brake system to operate to cause the vehicle system to move at the reference shaped speed that is calculated 740.

According to one embodiment, the reference shaped speed is calculated by linearly increasing or linearly decreasing a previous value of the reference shaped speed.

According to one embodiment, the reference shaped speed is calculated by increasing or decreasing a previous value of the reference shaped speed at a rate that changes based on a difference between a current value of the reference shaped speed and the current commanded speed. The rate is faster when the difference between the current value of the reference shaped speed and the current commanded speed is larger and the rate is slower when the difference between the current value of the reference shaped speed and the current commanded speed is smaller. The rate is a first designated rate when the difference between the current value of the reference shaped speed and the current commanded speed is larger than a designated value and the rate is a second designated rate that is slower than the first designated rate when the difference between the current value of the reference shaped speed and the current commanded speed is no larger than the designated value.

According to one embodiment, the reference shaped speed is calculated by increasing or decreasing a previous value of the reference shaped speed according to a time invariant first order model. According to one embodiment, the reference shaped speed is calculated by changing a previous value of the reference shaped speed at a rate that changes based on one or more of a weight of the vehicle system and the current moving speed. According to one embodiment, the current commanded speed is received from an operator input device, for example from the remote controller device or the onboard controller device. According to one embodiment, the current commanded speed is received from an automated control system.

A method may include applying a brake system of a multi-vehicle system using an onboard controller device of the multi-vehicle system and receiving grade input at the onboard controller device from a remote controller device, the grade input indicating a grade of a surface on which the multi-vehicle system is disposed. The method may further include starting movement of the multi-vehicle system responsive to receiving a speed command signal at the onboard controller device from the remote controller device, the movement of the multi-vehicle system started by initiating release of the brake system and/or generating tractive effort from a propulsion system of the multi-vehicle system, wherein starting the movement of the multi-vehicle system stretches the multi-vehicle system. The method may further include, responsive to the movement of the multi-vehicle system reaching a designated speed, switching to a closed loop control process of controlling the movement of the multi-vehicle system based on one or more of the speed command signal or a brake command signal received at the onboard controller device from the remote controller device.

Optionally, the grade input that is received at the onboard controller device may indicate that the multi-vehicle system is on an ascending grade, and the method may further include maintaining application of the brake system while concurrently increasing the tractive effort that is generated by the propulsion system. The method may further include determining whether the multi-vehicle system is rolling backward down the ascending grade and, responsive to determining that the multi-vehicle system is not rolling backward down the ascending grade, releasing the brake system while continuing to generate the tractive effort at a first threshold level. The method may further include, responsive to determining that the multi-vehicle system is rolling backward down the ascending grade, maintaining application of the brake system while concurrently generating the tractive effort at a second threshold level that is greater than the first threshold level.

Optionally, the grade input that is received at the onboard controller device may indicate that the multi-vehicle system is on a flat grade, and the method may further include releasing the brake system at a configurable slew rate and concurrently generating the tractive effort with the propulsion system until the multi-vehicle system is stretched or the multi-vehicle system is moving forward.

Optionally, the grade input that is received at the onboard controller device may indicate that the multi-vehicle system is on a descending grade, and the method may further include verifying that one or more traction motors of the propulsion system are set up for dynamic braking and releasing the brake system at a configurable slew rate. The method may further include determining whether the multi-vehicle system is moving forward and, responsive to determining that the multi-vehicle system is moving forward, engaging the one or more traction motors to dynamically brake to keep a moving speed of the multi-vehicle system to be no faster than the designated speed.

Optionally, the method may further include determining that the multi-vehicle system is rolling backward in contradiction to the grade input that was received and engaging the brake system to stop the multi-vehicle system from rolling backward. The method may further include building up generation of the tractive effort provided by the propulsion system while concurrently engaging the brake system until the multi-vehicle system no longer rolls backward and releasing the brake system.

Optionally, the closed loop control process of controlling the movement of the multi-vehicle system may include maintaining a speed of the multi-vehicle system at or within a threshold range of the speed command signal by alternating between (a) dynamically braking the multi-vehicle system using the propulsion system of the multi-vehicle system and (b) setting a throttle of the propulsion system to idle while the speed of the multi-vehicle system exceeds a designated stall speed of the multi-vehicle system to maintain the movement of the multi-vehicle. The method may further include applying the brake system of the multi-vehicle system responsive to (c) receiving an updated speed command signal at the onboard controller device from the remote controller device that reduces the speed of the multi-vehicle system and (d) the speed of the multi-vehicle system reaching the stall speed.

Optionally, the brake system of the multi-vehicle system includes independent brakes, and the closed loop control process of controlling the movement of the multi-vehicle system may include maintaining a speed of the multi-vehicle system at or within a threshold range of the speed command signal by alternating between (a) applying the independent brakes of the multi-vehicle system and (b) setting a throttle of the propulsion system to idle while the speed of the multi-vehicle system exceeds a designated stall speed of the multi-vehicle system to maintain the movement of the multi-vehicle. The method may further include applying the independent brakes of the multi-vehicle system responsive to (c) receiving an updated speed command signal at the onboard controller device from the remote controller device that reduces the speed of the multi-vehicle system and (d) the speed of the multi-vehicle system reaching the stall speed.

As used herein, the terms “processor” and “computer,” and related terms, e.g., “processing device,” “computing device,” and “controller” may be not limited to just those integrated circuits referred to in the art as a computer, but refer to a microcontroller, a microcomputer, a programmable logic controller (PLC), field programmable gate array, and application specific integrated circuit, and other programmable circuits. Suitable memory may include, for example, a computer-readable medium. A computer-readable medium may be, for example, a random-access memory (RAM), a computer-readable non-volatile medium, such as a flash memory. The term “non-transitory computer-readable media” represents a tangible computer-based device implemented for short-term and long-term storage of information, such as, computer-readable instructions, data structures, program modules and sub-modules, or other data in any device. Therefore, the methods described herein may be encoded as executable instructions embodied in a tangible, non-transitory, computer-readable medium, including, without limitation, a storage device and/or a memory device. Such instructions, when executed by a processor, cause the processor to perform at least a portion of the methods described herein. As such, the term includes tangible, computer-readable media, including, without limitation, non-transitory computer storage devices, including without limitation, volatile and non-volatile media, and removable and non-removable media such as firmware, physical and virtual storage, CD-ROMS, DVDs, and other digital sources, such as a network or the Internet.

The singular forms “a”, “an”, and “the” include plural references unless the context clearly dictates otherwise. “Optional” or “optionally” means that the subsequently described event or circumstance may or may not occur, and that the description may include instances where the event occurs and instances where it does not. Approximating language, as used herein throughout the specification and claims, may be applied to modify any quantitative representation that could permissibly vary without resulting in a change in the basic function to which it may be related. Accordingly, a value modified by a term or terms, such as “about,” “substantially,” and “approximately,” may be not to be limited to the precise value specified. In at least some instances, the approximating language may correspond to the precision of an instrument for measuring the value. Here and throughout the specification and claims, range limitations may be combined and/or interchanged, such ranges may be identified and include all the sub-ranges contained therein unless context or language indicates otherwise.

This written description uses examples to disclose the embodiments, including the best mode, and to enable a person of ordinary skill in the art to practice the embodiments, including making and using any devices or systems and performing any incorporated methods. The claims define the patentable scope of the disclosure, and include other examples that occur to those of ordinary skill in the art. Such other examples are intended to be within the scope of the claims if they have structural elements that do not differ from the literal language of the claims, or if they include equivalent structural elements with insubstantial differences from the literal language of the claims.

What is claimed is:

1. A method comprising:
applying a brake system of a multi-vehicle system using an onboard controller device of the multi-vehicle system;
receiving grade input at the onboard controller device from a remote controller device, the grade input indicating a grade of a surface on which the multi-vehicle system is disposed;
starting movement of the multi-vehicle system responsive to receiving a speed command signal at the onboard controller device from the remote controller device, the movement of the multi-vehicle system started by initiating release of the brake system and/or generating tractive effort from a propulsion system of the multi-vehicle system, wherein starting the movement of the multi-vehicle system stretches the multi-vehicle system; and
responsive to the movement of the multi-vehicle system reaching a designated speed, switching to a closed loop control process of controlling the movement of the multi-vehicle system based on one or more of the speed command signal or a brake command signal received at the onboard controller device from the remote controller device.

2. The method of claim 1, wherein the grade input that is received at the onboard controller device indicates that the multi-vehicle system is on an ascending grade, and further comprising:
maintaining application of the brake system while concurrently increasing the tractive effort that is generated by the propulsion system;
determining whether the multi-vehicle system is rolling backward down the ascending grade;
responsive to determining that the multi-vehicle system is not rolling backward down the ascending grade, releasing the brake system while continuing to generate the tractive effort at a first threshold level; and
responsive to determining that the multi-vehicle system is rolling backward down the ascending grade, maintaining application of the brake system while concurrently generating the tractive effort at a second threshold level that is greater than the first threshold level.

3. The method of claim 1, wherein the grade input that is received at the onboard controller device indicates that the multi-vehicle system is on a flat grade, and further comprising:
releasing the brake system at a configurable slew rate and concurrently generating the tractive effort with the propulsion system until the multi-vehicle system is stretched or the multi-vehicle system is moving forward.

4. The method of claim 1, wherein the grade input that is received at the onboard controller device indicates that the multi-vehicle system is on a descending grade, and further comprising:
verifying that one or more traction motors of the propulsion system are set up for dynamic braking;
releasing the brake system at a configurable slew rate;
determining whether the multi-vehicle system is moving forward; and
responsive to determining that the multi-vehicle system is moving forward, engaging the one or more traction motors to dynamically brake to keep a moving speed of the multi-vehicle system to be no faster than the designated speed.

5. The method of claim 1, further comprising:
determining that the multi-vehicle system is rolling backward in contradiction to the grade input that was received;
engaging the brake system to stop the multi-vehicle system from rolling backward;
building up generation of the tractive effort provided by the propulsion system while concurrently engaging the brake system until the multi-vehicle system no longer rolls backward; and
releasing the brake system.

6. The method of claim 1, wherein the closed loop control process of controlling the movement of the multi-vehicle system includes:
maintaining a speed of the multi-vehicle system at or within a threshold range of the speed command signal by alternating between (a) dynamically braking the multi-vehicle system using the propulsion system of the multi-vehicle system and (b) setting a throttle of the propulsion system to idle while the speed of the multi-vehicle system exceeds a designated stall speed of the multi-vehicle system to maintain the movement of the multi-vehicle; and
applying the brake system of the multi-vehicle system responsive to (c) receiving an updated speed command signal at the onboard controller device from the remote controller device that reduces the speed of the multi-vehicle system and (d) the speed of the multi-vehicle system reaching the stall speed.

7. The method of claim 1, wherein the brake system of the multi-vehicle system includes independent brakes, and the closed loop control process of controlling the movement of the multi-vehicle system includes:
maintaining a speed of the multi-vehicle system at or within a threshold range of the speed command signal by alternating between (a) applying the independent brakes of the multi-vehicle system and (b) setting a throttle of the propulsion system to idle while the speed of the multi-vehicle system exceeds a designated stall speed of the multi-vehicle system to maintain the movement of the multi-vehicle; and
applying the independent brakes of the multi-vehicle system responsive to (c) receiving an updated speed command signal at the onboard controller device from the remote controller device that reduces the speed of the multi-vehicle system and (d) the speed of the multi-vehicle system reaching the stall speed.
